(19) United States
(12) Patent Application Publication
(10) Pub. No.: US 2016/0049666 A1
(43) Pub. Date: Feb. 18, 2016

(54) CATHODE

(71) Applicants: JOHNSON MATTHEY PUBLIC LIMITED COMPANY, London (GB); TIMCAL LTD, Bodio (CH)

(72) Inventors: Sarah Caroline BALL, Oxon (GB); Robert John POTTER, Berkshire (GB); Marlene RODLERT, TI Breganzona (CH); Michael E SPAHR, TI Bellinzona (CH); Carmen SALCIANU, Albans (GB)

(21) Appl. No.: 14/782,432

(22) PCT Filed: Apr. 2, 2014
(86) PCT No.: PCT/GB2014/051032

§ 371 Date: Oct. 5, 2015

(30) Foreign Application Priority Data
Apr. 3, 2013 (GB) 1305997.7

(51) Int. Cl. H01M 4/96; H01M 12/08; H01M 4/86

(52) U.S. Cl. CPC H01M 4/96; H01M 4/8605; H01M 12/08; H01M 2004/8689

(57) ABSTRACT

The present invention provides use of a porous carbon material in a metal air battery, wherein the porous carbon material
(a) has a specific surface area (BET) of 100-600 m²/g, and
(b) has a micropore area of 10-90 m²/g.

The present inventors have found that this porous carbon material exhibits advantageous properties such as corrosion resistance.

### FIELD OF THE INVENTION

The present invention relates to a use of a porous carbon material in a metal air battery, and to air breathing cathodes and metal air batteries comprising the porous carbon material. The present invention also relates to methods for manufacturing an air-breathing cathode comprising the porous carbon material, and for manufacturing a metal air battery comprising the porous carbon material.

### BACKGROUND OF THE INVENTION

Energy storage, especially for transport applications, remains one of the major technology challenges for the 21^{st} century. Lithium-ion battery technology has played an important role powering portable devices. However, even the most advanced lithium-ion batteries for portable applications are reaching the limit of their practical capabilities and do not meet the requirements for transportation. Although a number of different battery systems exist, their lower theoretical energy densities make them less attractive for the electric vehicle (EV) market and they all have major technical challenges. Metal-air batteries, and in particular, lithium-air batteries, present the prospect of achieving the highest energy density possible for a practical, rechargeable battery. If the atomic mass of lithium alone is taken into consideration, a theoretical specific energy of around 13,000 Wh/kg may be calculated which is similar to the theoretical energy density of gasoline (13,200 Wh/kg). More realistic calculations that include the weight of oxygen, electrolyte and other cell components, still indicate a 3-5 fold improvement in specific capacity is achievable for lithium-air battery systems compared with current and near term lithium-ion battery technology.

A lithium-air battery essentially comprises a lithium-containing anode, an electrolyte and an air-breathing cathode. Lithium is oxidised at the anode forming lithium ions and electrons. The electrons flow through an external circuit and the lithium ions migrate across an electrolyte to the cathode where oxygen is reduced to form lithium oxides, such as Li₂O₂. The battery is recharged by applying an external potential; lithium metal is plated on the anode and oxygen is generated at the cathode. Lithium-air batteries can be classified into four different architectures depending on the type of electrolyte used: aprotic, aqueous, mixed aprotic/aqueous and solid state.

The aprotic cell design uses any liquid organic electrolyte capable of solvating lithium ion salts (e.g. LiPF₆, LiAsF₆, LiN(SO₂CF₃)₂ and LiSO₃CF₃), but have typically consisted of carbonates, ethers and esters. An advantage of using an aprotic electrolyte is that an interface between the anode and electrolyte is spontaneously formed which protects the lithium metal from further reaction with the electrolyte. Typically a liquid electrolyte filled porous separator is used to prevent physical contact and shorting between the anode and cathode. A solid polymer electrolyte may also be used, wherein lithium salts are dispersed in a polymer matrix capable of solvating the cations. Such polymers may also be pre-formed then swelled with the lithium-containing liquid electrolytes to improve conductivity or combined with liquid electrolytes or other plasticisers to form gel-polymer electrolytes. If the polymer is sufficiently robust a porous separator is not required, but reinforcement materials, such as a microporous web or fibres of a fluoropolymer such as PTFE as described in U.S. Pat. No. 6,254,978, EP 0814897 and U.S. Pat. No. 6,110,330, or polyvinylidene fluoride (PVDF), or alternative materials such as PEEK or polyethylene, may be incorporated into the polymer/gel. These various aprotic electrolytes may also be incorporated into the electrode structures to improve ionic conductivity. A problem associated with the use of an aprotic electrolyte is that the lithium oxides produced at the cathode are generally insoluble in the aprotic electrolyte leading to build up of the lithium oxides along the cathode/electrolyte interface. This can make cathodes in aprotic cells prone to clogging and volume expansion which reduces conductivity and degrades battery performance over time.

The aqueous cell design uses an electrolyte which is a combination of lithium salts dissolved in water, for example aqueous lithium hydroxide (alkali). The aqueous electrolyte could also be acidic. The problem of cathode clogging can be reduced since the lithium oxides formed at the cathode are water soluble, which allows aqueous lithium-air batteries to maintain their performance overtime. The aqueous cell also has a higher practical discharge potential than a cell using an aprotic electrolyte. A major problem, however, is that lithium reacts violently with water and therefore a solid electrolyte interface is required between the lithium metal and the aqueous electrolyte. The solid electrolyte interface is required to be lithium ion conducting, but the ceramics and glasses currently used only demonstrate low conductivities.

A mixed cell design uses an aprotic electrolyte adjacent to the anode and an aqueous electrolyte adjacent to the cathode, the two different electrolytes being separated by a lithium ion conducting membrane.

The solid-state design would appear attractive as it overcomes the problems at the anode and cathode when an aprotic or aqueous electrolyte is used. The anode and cathode are separated by a solid material. Such materials include glass ceramics such as lithium-aluminium-titanium-phosphate (LATP), lithium-aluminium-germanium-phosphate (LAGP) and silica doped versions, ceramic oxides with garnet type structures such as lithium-lanthanum-M oxides (M=Zr, Nb, Ta etc), perovskites such as lithium-lanthanum-titanates and other framework oxides including NASICON type structures (such as Na₃Zr₂PSi₂O₁₂). The main disadvantage of the solid-state design is the low conductivity of the glass-ceramic electrolyte.

Using an aprotic electrolyte is preferred to date, despite the disadvantages outlined above, because it currently provides substantially higher cell capacity.

Although the theoretical energy density of a lithium-air battery exceeds 5000 Wh/kg, the actual values obtained so far fall well short of this theoretical value. It is generally accepted that the performance limitations of lithium-air batteries are related to the air cathode. Accordingly, there remains a need for improved air breathing cathodes for metal air batteries, in particular for lithium-air batteries.

### SUMMARY OF THE INVENTION

The present inventors consider that improved performance and/or properties can be obtained by controlling the porosity of the cathode in metal-air batteries. In particular, the present inventors consider that by increasing the proportion of mesopores in a material of the cathode, and decreasing the proportion of micropores, improved properties and performance are obtained. For example, problems associated with cathode clogging can be reduced. Additionally, the cathode material may show improved corrosion resistance, and may show improved dispersion of catalyst or other material, where a catalyst or other material is supported on a surface of the porous cathode material. (Typically, mesopores are considered to be in the size range between about 2 and about 50 nm.)

Accordingly, in a first preferred aspect, the present invention provides use of a porous carbon material in a metal air battery, wherein the porous carbon material
(a) has a specific surface area (BET) of 100-600 m²/g, and
(b) has a micropore area of 10-90 m²/g.

It will be understood that the porous carbon material is electrically conductive.

In a second preferred aspect, the present invention provides an air breathing cathode for a metal air battery, comprising a porous carbon material having
(a) a specific surface area (BET) of 100-600 m²/g, and
(b) a micropore area of 10-90 m²/g.

Preferably, the air breathing cathode comprises a conductive current collector and a metal ion conductive medium, in addition to the porous carbon material.

In a further preferred aspect, the present invention provides a metal air battery comprising an air breathing cathode according to the present invention.

In a further preferred aspect, the present invention provides a method for the manufacture of an air breathing cathode comprising incorporating a porous carbon material into an air breathing cathode, wherein the porous carbon material has
(a) a specific surface area (BET) of 100-600 m²/g, and
(b) a micropore area of 10-90 m²/g.

The method may comprise preparing the porous carbon material, as described in more detail below. The method may be a method for the manufacture of a metal air battery, and accordingly may further comprise the step of assembling a metal air battery comprising the air breathing cathode.

The metal-air battery preferably comprises an air-breathing cathode according to the present invention, an anode and an electrolyte separating the anode and cathode.

### BRIEF DESCRIPTION OF THE DRAWINGS

FIG. 1 shows a schematic diagram of a Swagelok cell incorporating a metal-air battery according to an embodiment of the invention.

FIG. 2 shows a first discharge and charge 80 mA/gC for Example 7 and comparative Example 1 in a Lithium Air cell.

### DETAILED DESCRIPTION

Further preferred and/or optional features of the invention will now be set out. Any aspect of the invention may be combined with any other aspect of the invention, unless the context demands otherwise. Any of the preferred or optional features of any aspect may be combined, singly or in combination, with any aspect of the invention, unless the context demands otherwise.

### Porous Carbon Material

The porous carbon material has a specific surface area (BET) of 100 m²/g to 600 m²/g, suitably 250 m²/g to 600 m²/g, preferably 300 m²/g to 600 m²/g. In an alternative embodiment, the porous carbon material has a specific surface area (BET) of 100 m²/g to 500 m²/g, suitably 250 m²/g to 500 m²/g, preferably 300 m²/g to 500 m²/g. In a further alternative embodiment, the porous carbon material has a specific surface area (BET) of 100 m²/g to 400 m²/g, suitably 250 m²/g to 400 m²/g, preferably 300 m²/g to 400 m²/g, and most preferably 100 m²/g to 300 m²g. The determination of the specific surface area by the BET method is carried out by the following process: after degassing to form a clean, solid surface, a nitrogen adsorption isotherm is obtained, whereby the quantity of gas adsorbed is measured as a function of gas pressure, at a constant temperature (usually that of liquid nitrogen at its boiling point at one atmosphere pressure). A plot of 1/[Vₐ((P₀/P)−1)] vs P/P₀ is then constructed for P/P₀ values in the range 0.05 to 0.3 (or sometimes as low as 0.2), where V, is the quantity of gas adsorbed at pressure P, and P₀ is the saturation pressure of the gas. A straight line is fitted to the plot to yield the monolayer volume (Vₘ), from the intercept 1/VₘC and slope (C−1)/VₘC, where C is a constant. The surface area of the sample can be determined from the monolayer volume by correcting for the area occupied by a single adsorbate molecule. More details can be found in ‘Analytical Methods in Fine Particle Technology’, by Paul A. Webb and Clyde Orr, Micromeritics Instruments Corporation 1997.

The porous carbon material also has a micropore area of 10 m²/g to 90 m²/g, suitably 25 m²/g to 90 m²/g, more suitably 40 m²/g to 90 m²/g when determined by the method described below. Alternatively, the porous carbon material has a micropore area of 10 m²/g to 80 m²/g, suitably 25 m²/g to 80 m²/g, more suitably 40 m²/g to 80 m²/g when determined by the method described below. In a further alternative embodiment, the porous carbon material has a micropore area of 10 m²/g to 75 m²/g, suitably 25 m²/g to 75 m²/g, more suitably 40 m²/g to 75 m²/g when determined by the method described below. In a further alternative embodiment, the porous carbon material has a micropore area of 10 m²/g to 60 m²/g, suitably 25 m²/g to 60 m²/g, more suitably 40 m²/g to 60 m²/g when determined by the method described below. In a further alternative embodiment, the porous carbon material has a micropore area of 10 m²/g to 50 m²/g, suitably 25 m²/g to 50 m²/g, more suitably 40 m²/g to 50 m²/g when determined by the method described below. In a further alternative embodiment, the porous carbon material has a micropore area of 10 m²/g to 45 m²/g, suitably 25 m²/g to 45 m²/g, more suitably 40 m²/g to 45 m²/g when determined by the method described below. The micropore area refers to the surface area associated with the micropores, where a micropore is defined as a pore of internal width less than 2 nm. The micropore area is determined by use of a t-plot, generated from the nitrogen adsorption isotherm as described above. The t-plot has the volume of gas adsorbed plotted as a function of the standard multilayer thickness, t, where the t values are calculated using the pressure values from the adsorption isotherm in a thickness equation; in this case the Harkins-Jura equation. The slope of the linear portion of the t-plot at thickness values between 0.35 and 0.5 nm is used to calculate the external surface area, that is, the surface area associated with all pores except the micropores. The micropore surface area is then calculated by subtraction of the external surface area from the BET surface area. More details can be found in ‘Analytical Methods in Fine Particle Technology’, by Paul A. Webb and Clyde Orr, Micromeritics Instruments Corporation 1997. At a defined relative pressure towards the upper limit of the adsorption isotherm (usually P/Po=0.99) a gas volume may be measured and converted to a pore volume as described in ‘Characterisation of Porous Solids and Powders: Surface Area, Pore Size and Density’ by S. Lowell, J. E. Shields, M. A. Thomas and M. Thommes, Springer 2006. In a particularly preferred embodiment the porous carbon material has a pore volume of up to 1cc/g determined at P/Po=0.99.

In a particularly preferred embodiment, the porous carbon material has a specific surface area (BET) of 100 m²/g to 300 m²/g, and a micropore area of 10 m²/g to 45 m²/g, preferably 25 m²/g to 45 m²/g. In another particularly preferred embodiment, the porous carbon material has a specific surface area (BET) of 300 m²/g to 600 m²/g, and a micropore area of 10 m²/g to 90 m²/g, preferably 25 m²/g to 90 m²/g or 25 m²/g to 80 m²/g. In another particularly preferred embodiment, the porous carbon material has a specific surface area (BET) of 300 m²/g to 500 m²/g, and a micropore area of 10 m²/g to 75 m²/g, preferably 25 m²/g to 75 m²/g.

The percentage of the total specific surface area (BET) which is micropore area may be 30% or less, 25% or less, 20% or less, 17% or less or 15% or less. The lower limit is not particularly limited in the present invention, but the % of the total BET surface area which is micropore area may be at least 1%, at least 3%, at least 5% at least 7%, at least 8% or at least 10%. The percentage of the total specific surface area (BET) which is micropore area may be calculated by dividing the micropore area by the specific surface area (BET) of the porous carbon material.

Preferably, the porous carbon material also loses 20% or less, suitably 18% or less, more suitably 11% or less of its mass in an accelerated test involving a 1.2V potential hold over a 24 hour period at 80° C. The loss of carbon can be determined by the following commonly accepted test used by those skilled in the art and as described in more detail in Journal of Power Sources, Volume 171, Issue 1, 19 September 2007, Pages 18-25: an electrode of the chosen catalyst or carbon is held at 1.2V in 1 M H₂SO₄ liquid electrolyte vs. Reversible Hydrogen Electrode (RHE) and 80° C. and the corrosion current monitored over 24hrs. Charge passed during the experiment is then integrated and used to calculate the carbon removed, assuming a 4 electron process converting carbon to CO₂ gas; the first 1 min of the test is not included as the charge passed during this time is attributed to the charging of the electrochemical double layer and therefore not due to corrosion processes. The mass of carbon lost during the 24 hr test is then expressed as a percentage of the initial carbon content of the electrode.

Furthermore, the carbon support material has a specific corrosion rate of less than 65%, suitably less than 60%, preferably such as less than 50%. The specific corrosion rate is determined by expressing the amount of carbon corroded as a percentage of the number of surface carbon atoms. Assuming 3.79×10¹⁹ atoms m⁻² of carbon and a four-electron process, the maximum charge required to remove one monolayer of the carbon is determined. The experimentally determined charge associated with carbon corrosion is then expressed as a percentage of a monolayer, giving the specific corrosion rate.

While the above parameters typically relate to performance in a fuel cell environment, the present inventors consider that where advantageous mass loss and specific corrosion rate are identified in the tests described above, similar corrosion resistance may likely be observed in a metal air battery application. The application of similar tests in an aprotic environment is complicated by the instability of the aprotic organic electrolytes typically used, in battery systems which may be oxidised at higher charging potentials, which makes distinguishing oxidative current and carbon dioxide evolved from carbon support corrosion alone rather challenging. Thus the simpler screening protocol in aqueous media described above may still be of value to assess the general propensity of the carbon surface to be oxidised at higher potentials in the presence of water or other active species such oxygen and the superoxide which are present in metal air battery cathode reactions.

The porous carbon material can be obtained by functionalization of a pre-existing carbon material. Functionalization or activation of carbon has been described in the literature and is understood in the case of physical activation as a post treatment of carbon with gases like oxygen or air, carbon dioxide, steam, ozone, or nitrogen oxide or in the case of a chemical activation as a reaction of the carbon pre-cursor with solid or liquid reagents like KOH, ZnCl₂ or H₃PO₄ at elevated temperatures. Examples of such functionalization or activation are described by H. Marsch and F. Rodriguez-Reinoso in ‘Activated Carbon’, Elsevier Chapter 5 (2006). During the activation process parts of the carbon is lost by the chemical reaction or burn-off.

The activation of carbon black is typically performed with oxidizing gases such as oxygen, ozone, hydrogen peroxide, or nitrogen dioxide which, as well as leading to an increase of the specific surface area, also leads to an increasing amount of surface groups. Activation can also be performed by air, carbon dioxide or steam treatment, which mainly affects the carbon black porosity, for example as described in ‘Carbon Black’ (J-B. Donnet, R. C. Bansal and M-J Wang (eds.), Taylor & Francis, 62-65 (1993)). It may be preferred that the porous carbon material is obtained or obtainable by treatment of carbon black, for example treatment as described and/or defined herein.

The present inventors have found that control of the activation process can provide carbon material having the specific surface area and micropore area defined herein. For example, the length of treatment, temperature employed and the nature of the gas, solid or liquid used to treat the carbon may be varied to provide the desired properties. As the skilled person will readily understand, the nature of the activation process required to provide the desired specific surface area and micropore area may depend, for example, on the nature of the carbon starting material being treated.

It may be preferred that the treatment is carried out in a fluidised bed reactor. Carbon starting material may be fluidised in a flow of inert gas. The carbon to be treated may be heated (e.g. gradually heated) to a temperature in the range from 800° C. to 1100° C., and held at that temperature for a time e.g. ranging from 30 minutes to 4 hours. During the heat treatment time, a reacting gas (for example selected from the gases proposed above) may be supplied to the carbon. Preferably, the reacting gas is selected from air, carbon dioxide or steam. Preferably, the treatment provides a porous carbon material having a specific surface area and micropore area as defined herein.

The porous carbon material may be active as a cathode material (e.g. to form lithium peroxide on discharge) without the need for further catalytic material to be provided.

However, it may be desirable to provide additional catalyst material, e.g. on the surface of the porous carbon material. Alternatively, further material(s), e.g. metal oxide materials, may be combined with the porous carbon material by mixing the two materials.

Inclusion of a primary metal, or an alloy, mixture or compound (e.g. oxide) including the primary metal in the air breathing cathode of the present invention may assist in catalysing recharging of the metal air battery, and may also assist in discharge of the metal air battery.

In some embodiments, a primary metal or an alloy, mixture or compound comprising the primary metal may be combined with the porous carbon support (e.g. provided on the surface of the porous carbon support). Suitably, the primary metal is selected from
(i) precious metals the platinum group metals (platinum, palladium, rhodium, ruthenium, iridium and osmium) and gold and silver, or
(ii) a transition metal such as molybdenum, tungsten, cobalt, chromium, nickel, iron, copper
(iii) a base metal
or an oxide thereof.

The primary metal may be alloyed or mixed with one or more other precious metals, or base metals such as molybdenum, tungsten, cobalt, chromium, nickel, iron, copper or an oxide of a precious metal or base metal. The primary metal may be platinum, gold or ruthenium. In other embodiments, the primary metal is a transition metal, e.g. in the form of a transition metal oxide.

In the Examples below, where platinum has been deposited on the surface of the porous carbon material of the present invention, the gas phase metal area was determined using gas phase adsorption of carbon monoxide (CO). A high Pt surface area determined by this method is known to translate to high electrochemical surface area under fuel cell testing conditions, and may be illustrative of good performance in metal air battery applications.

Accordingly, it may be preferable that the porous carbon material has (when a metal such as platinum is deposited on its surface) a gas phase metal area, determined using gas phase adsorption of carbon monoxide (CO), of at least 30 m²/g, suitably at least 45 m²/g, more preferably at least 60 m²/g, The gas phase CO metal area is determined by reducing the catalyst in hydrogen, then titrating aliquots of CO gas until there is no more uptake. The moles of CO absorbed can then be converted into a metal surface area, by assuming 1.25×10¹⁹atoms/m² for Pt as defined in ‘Catalysis—Science and Technology, Vol 6, p 257, Eds J. R. Anderson and M. Boudart.

Where a catalyst is provided, the loading of catalyst, e.g. primary metal particles on the porous carbon material is suitably in the range 0.1-95wt %, preferably 5-75wt %. The actual loading of the catalyst (e.g. primary metal particles) on the porous carbon material will be dependent on the ultimate use of the catalyst.

### Air Breathing Cathode

Preferably, the air breathing cathode according to the present invention, and prepared by methods of the present invention, comprises a conductive current collector and a metal ion conductive medium, in addition to the porous carbon material.

As the skilled person will understand, typically air breathing cathodes comprise a porous conductive material. Advantageously, the porous carbon material of the present invention is typically a porous conductive material. In this way, it may not be necessary to provide a further porous conductive material in order to form the air breathing cathode.

In some embodiments, the porous carbon material of the present invention may be combined with one or more further porous conductive materials in order to from the air breathing cathode. In other embodiments, the porous conductive material of the air breathing cathode consists essentially of porous carbon material of the present invention.

Where the air-breathing cathode comprises a further porous conductive material in addition to the porous carbon material of the present invention, the nature of the further porous conductive material is not particularly limited provided it is porous and conductive. Examples include carbon black such as ketjen black, acetylene black; graphite, such as natural graphite; conductive fibres, such as carbon fibres and metal fibres, powders of a metal such as copper, silver, nickel or aluminium; carbon nanotubes or arrays of carbon nanotubes; organic conductive materials such as polyphenylene derivatives, polypyrrole and polyaniline and materials that are conducting once carbonised such as polyvinylpyrollidone and polyacrilonitrile; or a mixture of one or more of these. The further porous conductive material may also be a high surface area carbon such as Super P (TIMCAL), XC-72R (CABOT) ketjen EC300J (Akzo Nobel) and graphitised or functionalised carbon supports. The conductive current collector in the air-breathing cathode of the invention should allow air/oxygen to diffuse through, and may be any suitable current collector known to those skilled in the art. Example of suitable conductive current collectors includes meshes or grids, for example of metal such as aluminium, stainless steel, titanium or nickel. The conductive current collector may also be a graphite plate with channels provided in one face through which air/oxygen can flow. The conductive current collector may also comprise a gas diffusion layer applied to one face thereof. Typical gas diffusion layers are suitably based on conventional non-woven carbon fibre gas diffusion substrates such as rigid sheet carbon fibre papers (e.g. the TGP-H series of carbon fibre papers available from Toray Industries Inc., Japan) or roll-good carbon fibre papers (e.g. the H2315 based series available from Freudenberg FCCT KG, Germany; the Sigracet® series available from SGL Technologies GmbH, Germany; the AvCarb® series available from Ballard Material Products, United States of America; or the NOS series available from CeTech Co., Ltd. Taiwan), or on woven carbon fibre cloth substrates (e.g. the SCCG series of carbon cloths available from the SAATI Group, S.p.A., Italy; or the WOS series available from CeTech Co., Ltd, Taiwan).

The metal-ion conducting medium in the air-breathing cathode of the invention may be any of the liquid or solid electrolyte materials previously described dispersed throughout the cathode such that good lithium ion mobility, O₂ access and electrical conductivity are maintained. Suitably, the metal-ion conducting medium is lithium-ion conducting. For example, a lithium salt is dissolved/dispersed in a suitable aprotic liquid, water or solid electrolyte material, such as a solid polymer electrolyte or a solid glass ceramic material. Suitable lithium salts include, but are not limited to: lithium perchlorate (LiClO₄), lithium hexafluoro phosphate (LiPF₆), lithium bis(trifluoromethanesulphonyl)imide (LiTFSI), lithium bis(pentafluoroethane sulphonyl)imide (LiBETI), lithium 4-5-dicyano-2-trifluromethyl imidazole (LiTDI). Suitable aprotic liquids include, but are not limited to: carbonates (such as propylene carbonate (PC), dimethyl carbonate (DMC), diethylcarbonate, ethylene carbonate (EC)) or ethers/glymes (such as dimethyl ether (DME) and tetraglyme) or ionic liquids (such as 1-ethyl-3-methylimidazolium-bis(trifluoromethylsulfonyl)imide (EMITFSI), N-methyl-N-proopylpiperidinium bis(trifluoromethanesulfonyl)imide (PP13-TFSI)). Suitable solid polymer electrolyte materials include, but are not limited to, polymers which may contain oxygen, nitrogen, fluorine or sulphur donor atoms in the polymer chain to solvate the cations, such as polyethylene oxide (PEO), polyamine and polysulphides or other polymers such as polyvinylidine fluoride PVDF or copolymers such as poly(vinylidine fluoride-hexafluoropropylene) (PVDF-HFP). A gel-polymer electrolyte may also be produced by combining these liquid electrolyte and solid polymer components and/or addition of a plasticiser (such as PC, ethylene carbonate, borate derivatives with poly(ethylene glycol) B-PEG) to the polymer.

The air-breathing cathode of the invention may also comprise a binder. The binder may be selected from the group consisting of polyethylene, polypropylene, polytetrafluoroethylene (PTFE), polyvinylidenefluoride (PVDF), styrene-butadiene rubber, tetrafluoroethylene-hexafluoroethylene (PTFE-HFP) copolymer, polyvinylidenefluoride-hexafluoropropylene copolymer (PVDF-HFP), tetrafluoroethylene-perfluoroalkyl vinyl ether copolymer, vinylidene fluoride-hexafluoropropylene copolymer, vinylidene fluoride-chlorotrifluoroethylene copolymer, ethylene-tetrafluoroethylene copolymer, polychlorotrifluoroethylene, vinylidene fluoride-pentafluoropropylene copolymer, propylene-tetrafluoroethylene copolymer, ethylene-chlorotrifluoroethylene copolymer, vinylidene fluoride-hexafluoropropylene-tetrafluoroethylene copolymer, vinylidene fluoride-perfluoromethyl vinyl ether-tetrafluoroethylene copolymer, ethylene-acrylic acid copolymer or a mixture thereof. Specific examples include PVDF, PVDF-HFP and perfluorinated sulphonic acid (e.g. Nafion) and lithium-exchanged PFSAs.

The air-breathing cathode of the invention may be made by mixing the metal-ion conducting medium, and the porous carbon material of the present invention in a suitable polar solvent (e.g. acetone, NMP, DEK, DMSO, water, alcohols, ethers and gycol ethers and organic carbonates) and either casting as a free standing film or coating onto the conductive current collector. If present, the further porous conductive material and/or the binder are also mixed in with the polar solvent. Where a metal or metal oxide are to be mixed with the porous carbon material (e.g. as described above) the metal or metal oxide may also be mixed with the polar solvent. Optionally, the metal or metal oxide may be milled together with the porous carbon material prior to mixing with the polar solvent. Casting a free-standing film or coating onto the conductive current collector may be carried out by K-bar coating, doctor blade, screen printing, spraying or brush coating or dip coating. In one embodiment, the free standing film is first cast onto a transfer release substrate, such as PTFE, or glass sheet and is then subsequently transferred and affixed to the conductive current collector by lamination via hot pressing or cold pressing. The air breathing-cathode layer may also be applied directly onto a solid polymer or other solid electrolyte layer by various techniques including those described above. The air breathing cathode may also be cast or coated directly onto a solid Li conducting electrolyte, such as a polymer, glass or ceramic free standing film.

Alternatively, the air-breathing cathode of the invention may be made by mixing the porous carbon material of the present invention in a suitable polar solvent (e.g. acetone, NMP, DEK, DMSO, water, alcohols, ethers and gycol ethers and organic carbonates) and either casting as a free standing film or coating onto the conductive current collector. If present, the further porous conductive material and/or the binder are also mixed in with the polar solvent. Where a metal or metal oxide are to be mixed with the porous carbon material (e.g. as described above) the metal or metal oxide may also be mixed with the polar solvent. Optionally, the metal or metal oxide may be milled together with the porous carbon material prior to mixing with the polar solvent. The metal-ion conducting medium is then applied to the free-standing film or coating so that it impregnates into the free-standing film or coating. The free standing film is then transferred to the current collector by methods described above.

Where catalyst is loaded onto the surface of the porous carbon material, typically the catalyst is loaded before the porous carbon material is mixed with the polar solvent, in either of the methods described above.

### Metal Air Battery

As discussed above, the present invention provides a metal-air battery comprising an air-breathing cathode according to the present invention, an anode and an electrolyte separating the anode and cathode.

The anode comprises an anode layer having an active anode material and an anode current collector. The active anode material suitably comprises a metal element capable of absorbing and releasing metal ions. Examples of the metal element include, but are not limited to, the alkali metals (e.g. Na, Li, K), alkaline earth metals (e.g. Mg, Ca), amphoteric metals (e.g. Zn, Al, Si) and transition metals (e.g. Fe, Sn, Ti, Nb, W). Preferably, the metal element is an alkali metal, in particular lithium. The metal element is present as the metal, an alloy (e.g. with tin or silicon), an oxide, a nitride, a sulphide, carbide or as in intercalation product with e.g. carbon, silicon etc. Preferably, the metal element is present as the metal. Other materials commonly used in lithium ion battery technology such as Li₅Ti₄O₁₂, silicon, graphites, carbon nano-tubes, lithium metal or lithium metal alloys may also be used. The anode current collector is not particularly limited, provided that the material is conductive. Examples may include a metal, alloy, carbon etc and may be in the form of a foil, mesh, grid etc. Suitable anode current collectors would be known to the skilled person.

The electrolyte may be aprotic, aqueous, mixed or a solid and may be of any material provided it has the capability of conducting metal ions.

In one embodiment, the electrolyte is aprotic wherein a lithium salt is dissolved in a suitable aprotic liquid. Suitable lithium salts include, but are not limited to: lithium perchlorate (LiClO₄), lithium hexafluoro phosphate (LiPF₆), lithium bis(trifluoromethanesulphonyl)imide (LiTFSI), lithium bis(pentafluoroethane sulphonyl)imide (LiBETI), lithium 4-5-dicyano-2-trifluromethyl imidazole (LiTDI). Suitable aprotic liquids include, but are not limited to: carbonates (such as propylene carbonate (PC), dimethyl carbonate (DMC), diethylcarbonate, ethylene carbonate (EC)) or ethers/glymes (such as dimethyl ether (DME) and tetraglyme) or ionic liquids (such as 1-ethyl-3-methylimidazolium-bis(trifluoromethylsulfonyl)imide (EMITFSI), N-methyl-N-proopylpiperidinium bis(trifluoromethanesulfonyl)imide (PP13-TFSI)).

In a further embodiment, the electrolyte is an aqueous liquid, for example aqueous lithium hydroxide. Alternatively, the aqueous electrolyte is acidic. If an aqueous electrolyte is used, a solid electrolyte interface is required between the anode and the electrolyte to prevent reaction of the anode with the aqueous electrolyte.

When liquid electrolytes are used, such as an aprotic or aqueous electrolyte, a porous separator is required between the anode and cathode to prevent electrical shorting and the metal air battery is configured such that the porous separator is impregnated with the liquid electrolyte. Examples of separator materials include porous films of polyethylene (for example expanded polytetrafluoroethylene), polypropylene, woven or non-woven fabric or glass fibre, or combinations of these or other components as composites/multilayer structures.

In a still further embodiment, the electrolyte is a solid or gel. For example, the electrolyte may be a solid polymer material having lithium salts dissolved or dispersed therein. For example, a lithium salt such as lithium perchlorate (LiClO₄), lithium hexafluoro phosphate (LiPF₆), lithium bis(trifluoromethanesulphonyl)imide (LiTFSI), lithium bis(pentafluoroethane sulphonyl)imide (LiBETI), lithium 4-5-dicyano-2-trifluromethyl imidazole (LiTDI) is dissolved/dispersed in a polymer which contains oxygen, nitrogen, fluorine or sulphur donor atoms in the polymer chain to solvate the cations, such as polyethylene oxide (PEO), polyamine and polysulphides or other polymers such as polyvinylidine fluoride PVDF or copolymers such as poly(vinylidine fluoride-hexafluoropropylene) (PVDF-HFP). The polymer solution/dispersion is then cast to form an electrolyte membrane to be present in between the anode and cathode. Examples of gel electrolytes suitable or use in the present invention include, but not limited to, gel electrolytes composed of a polymer such as poly(vinylidene fluoride), poly(ethyleneglycol) or polyacrylonitrile; an amino acid derivative; or a saccharide such as a sorbitol derivative containing an electrolyte solution containing a lithium salt as hereinbefore described. If the polymer/gel is sufficiently robust a porous separator is not required, but reinforcement materials, such as a microporous web or fibres of a fluoropolymer such as PTFE as described in U.S. Pat. No. 6,254,978, EP 0814897 and U.S. Pat. No. 6,110,330, or polyvinylidene fluoride (PVDF), or alternative materials such as PEEK or polyethylene, may be incorporated into the polymer/gel.

In a yet further embodiment, the electrolyte is a solid glass ceramic material, for example lithium-aluminium-titanium-phosphate (LATP), lithium-aluminium-germanium-phosphate (LAGP) and silica doped versions, ceramic oxides with garnet type structures such as lithium-lanthanum-M oxides (M=Zr, Nb, Ta etc), perovskites such as lithium-lanthanum-titanates and other framework oxides including NASICON type structures (such as Na₃Zr₂PSi₂O₁₂).

The metal-air battery may be constructed by techniques known to those in the art.

The metal-air batteries of the present invention may be used for portable, stationary or transport applications.

The invention will now be further described with reference to the following examples, which are illustrative and not limiting of the invention.

### EXAMPLES

Comparative Examples are the following:

Comparative Example 1 Super P Li available from TIMCAL Ltd

Comparative Example 2: Ensaco™ 250G available from Timcal Ltd

Comparative Example 3: Vulcan XC-72R available from Cabot Corporation

Comparative Example 4: Ketjen EC 300J available from Akzo Nobel

Comparative Example 5: Ketjen EC 300J graphitised at high temperature >2000° C.

Carbons for Examples 1 to 7 were prepared by physical functionalization of granulated highly structured conductive carbon black Ensaco® 250G (Comparative Example 2) in a fluidized bed reactor. The carbon material (800-1200 g) was introduced in the reaction chamber at room temperature. A flow of inert gas (nitrogen) was introduced in order to fluidize the carbon material. The chamber was slowly heated up to 800°-1100° C., where it was kept at constant temperature with a flow of reacting gas for a time ranging between 30 minutes and 4 hours. The reacting gas used was air, carbon dioxide, or steam. The reaction time controlled the degree of the post treatment with the individual gas at a given gas flow and reactor design. Thereafter the reaction chamber with the post treated carbon material was left to cool down to room temperature under a flow of inert gas.

TABLE 1
Properties of carbon supports and catalysts

| | | | Corrosion Test | |
|---|---|---|---|---|
| | | | (1.2 V, 24 hours, 80° C., | |
| | Carbon surface area | | aqueous media) | |
| | (m²/g) | | | Specific |
| | | Surface | Absolute | corrosion % |
| | | Area in | corrosion wt % | monolayer |
| Example | Total (BET) | Micropores | carbon loss | corroded |
| Comparative | 62 | 4 | Not determined | — |
| Example 1 | | | | |
| Comparative | 65 | 5 | 2.5 | 52 |
| Example 2 | | | | |
| Comparative | 226 | 96 | 12 | 67 |
| Example 3 | | | | |
| Comparative | 846 | 169 | 32 | 51 |
| Example 4 | | | | |
| Comparative | 124 | 7 | 1 | 10 |
| Example 5 | | | | |
| Example 1 | 110 | 28 | 5.3 | 64 |
| Example 2 | 196 | 40 | 7.2 | 49 |
| Example 3 | 262 | 41 | 9.7 | 49 |
| Example 4 | 337 | 42 | 9.1 | 37 |
| Example 5 | 396 | 33 | 9 | 26 |
| Example 6 | 541 | 74 | 16.6 | 41 |
| Example 7 | 466 | 65 | 17.8 | 51 |

Examples 1-7 were prepared by application of the carbon treatment process to Comparative Example 2. The total BET surface area of Examples 1 to 7 was increased by the application of the carbon treatment process, however whilst the overall carbon BET surface area increased, the proportion of area in micropores decreased accompanied by a decrease in the specific corrosion rate. This resulted in a plateauing of the absolute corrosion determined by wt % carbon loss. The general propensity of the carbon surface to corrosion by active species such as water, oxygen may be assessed by determining the wt % of carbon lost in a voltage hold and is thought transferrable to metal air systems. Thus the application of the treatment process creates a support surface that is less intrinsically corrodible (exhibiting a lower specific corrosion rate), such that a carbon with greater overall BET surface area (Examples 3, 4 and 5) can show lower absolute corrosion than a commercial carbon with lower BET surface area (such as Comparative Example 3).

To provide an assessment of the ability to disperse catalyst (e.g. metal) nanoparticles on the carbon materials of the invention compared with the comparative examples, Pt nanoparticles were deposited on selected carbon supports and the dispersion measured.

In order to deposit the Pt on the surface of the carbon porous carbon material, 1 g of the carbon material was dispersed in water (150 ml) using a shear mixer. The slurry was transferred to a beaker (if required with 50 ml additional water), fitted with temperature and pH probes and two feed inlet tubes connected to a pH control unit. The Pt salt (Pt nitrate or K₂PtCl₄) was added in an amount sufficient to give a nominal loading of 60wt % Pt (Examples 1 to 5) and a nominal loading of 50 wt % Pt (Examples 6 and 7). NaOH was added to maintain the pH between 5.0 and 7.0 (final pH). The slurry was stirred and once hydrolysis was complete, formaldehyde was added to reduce the Pt. Once the reaction was complete, the porous carbon material having platinum deposited thereon was recovered by filtration and washed on the filter bed. The material was dried overnight at 105° C.

Specific data in Table 1 above illustrate an additional benefit of the carbons of the invention whereby improved metal nanoparticle dispersion (in this example Pt) may be achieved for a given carbon surface area, compared with other approaches to treat carbon supports.

Comparative Example 5 is representative of a carbon support prepared by graphitisation of a high surface area carbon support by heat treatment at high temperature >2000° C. These typically have low BET areas and low surface area in micropores; however exact properties are dependent on the graphitisation temperature. Typically catalysation of such carbon supports results in low Pt dispersion (28 m²/gPt) due to the lower surface functionality of the graphitised carbon support compared with Pt deposited on carbon Example 3 of the invention (45 m²/gPt).

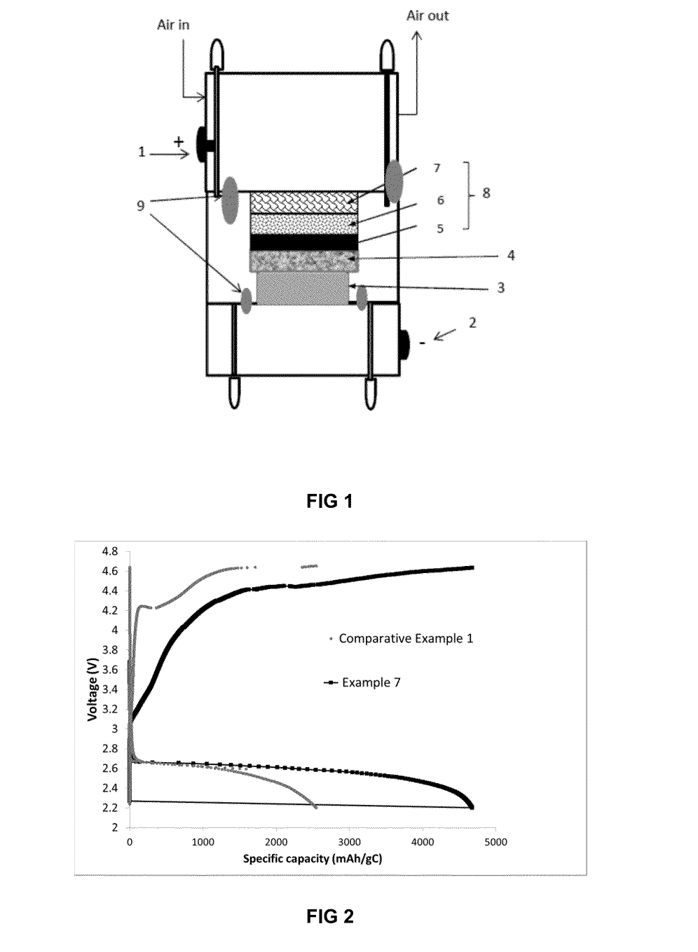

The carbon in Example 7 of the invention and binder (Kynarflex 2801 Arkema) were mixed in solvent (NMP) and coated onto Toray TGPH60 (available from Toray Industries) by K-bar coating. The cathode current collector was stainless steel. The air-breathing cathode and the metal-air battery was constructed in situ in a Swagelok cell as depicted in FIG. 1. A similar sample was prepared using Comparative Example 1.

The cell shown in FIG. 1 includes the following features, indicated by reference numbers in the Figure:

| | |
|---|---|
| 1 | Positive terminal |
| 2 | Negative terminal |
| 3 | Lithium metal |
| 4 | Separator |
| 5 | Cathode active layer |
| 6 | Toray TGPH60 |
| 7 | Cathode current collector |
| 8 | Cathode |
| 9 | O-rings |

The metal-air battery had an active area of 2 cm² defined by the 2 cm² lithium metal anode area. The anode and cathode were isolated from each other using a polypropylene separator filled with liquid electrolyte. The electrolyte solution was 1 M LiTFSI in tetraglyme. The separator and cathode electrode area were slightly larger such that the separator overlapped the anode and prevented any shorting. The cathode current collector was attached to a rod passing through the cell housing via an o-ring seal, so that the rod and cathode current collector could be moved towards the uncoated face of the Toray TGPH60 to ensure contact between all the components. Gas porting into and out of the cathode compartment allowed gases to be flowed through the air cathode and also the cell to be isolated from the external atmosphere. The cells were built in an Ar glove box (O₂ and H₂O<1 ppm).

Cell testing involved measurement of the open circuit potential in the absence and presence of air flow, followed by discharge and charge cycles at particular currents using a Maccor 4300 battery tester. A current of 80 mA/gC was used for comparisons between different cathode types, with currents calculated based on the electrode carbon loading and an active area of 2 cm². Cells were discharged at the selected current density until the test cut off voltage of 2V was reached, then recharged at the same current density until a total charge=100% of the discharged amount had been passed, or an upper cut off voltage limit of 4.8V was reached. Data were then corrected for the electrode carbon loading and plotted as charge per carbon weight (specific capacity).

FIG. 2 shows performance in lithium air Swagelok cells in the presence of a dry Air flow showing enhanced discharge capacity, higher voltage on discharge and lower recharge voltage for Example 7 compared with Comparative Example 1.

1. A porous carbon material having
(a) a specific surface area (BET) of 100-600 m²/g, and
(b) a micropore area of 10-90 m²/g

2. The porous carbon material according to claim 1, wherein the specific surface area (BET) is 100 m²/g to 300 m²/g, and the micropore area is 10 m²/g to 45 m²/g.

3. The porous carbon material according to claim 1, wherein the specific surface area (BET) is 300 m²/g to 600 m²/g, and the micropore area is 10 m²/g to 90 m²/g, preferably 25 m²/g to 90 m²/g.

4. The porous carbon material according to claim 1, wherein the specific surface area (BET) is 300 m²/g to 500 m²/g, and the micropore area is 10 m²/g to 75 m²/g, preferably 25 m²/g to 75 m /g.

5. The porous carbon material according to claim 1, wherein the percentage of the total specific surface area (BET) which is micropore area is 30% or less.

6. The porous carbon material according to claim 1, wherein the porous carbon material is electrically conductive.

7. The porous carbon material according to claim 1, wherein the porous carbon material is used in an air breathing cathode of the metal air battery.

8. The porous carbon material according to claim 1, wherein the metal air battery is a lithium air battery.

9. An air breathing cathode for a metal air battery, comprising a porous carbon material having
(a) a specific surface area (BET) of 100-600 m²/g, and
(b) a micropore area of 10-90 m²/g.

10. An air breathing cathode according to claim 9 further comprising a conductive current collector and a metal ion conducting medium.

11. A metal air battery comprising an anode, an air breathing cathode according to claim 9, and an electrolyte between the anode and the air breathing cathode.

12. A method for the manufacture of an air breathing cathode comprising incorporating a porous carbon material into an air breathing cathode, wherein the porous carbon material has
(a) a specific surface area (BET) of 100-600 m²/g, and
(b) a micropore area of 10-90 m²/g.

13. The method according to claim 12 wherein the porous carbon material is prepared by treating a carbon starting material to provide a porous carbon material having
(a) a specific surface area (BET) of 100-600 m²/g, and
(b) a micropore area of 10-90 m²/g.

14. A method for the manufacture of a metal air battery comprising (i) preparing an air breathing cathode by a method as defined in claim 12, and assembling a metal air battery comprising the air breathing cathode.
